(19) United States
(12) Patent Application Publication
(10) Pub. No.: US 2006/0131088 A1
(43) Pub. Date: Jun. 22, 2006

(54) Dashboard for a motor vehicle

(75) Inventors: Wolfgang Pawusch, Hochheim (DE); Manfred Wehner, Wolfersheim (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munich (DE)

(21) Appl. No.: 11/223,147

(22) Filed: Sep. 12, 2005

(30) Foreign Application Priority Data
Sep. 13, 2004 (DE) 10 2004 044 163.4

(51) Int. Cl. B62D 25/14; B60Q 1/00

(52) U.S. Cl. 180/90; 340/461

(57) ABSTRACT

The invention relates to a dashboard for a motor vehicle, with a screen for displaying information, the screen being arranged in front of the dashboard as seen by a vehicle occupant. In order to form a dashboard such that the screen can be read equally well both by the driver and by the passenger, depending on requirements, with the installation space in the region of the dashboard at the same time being utilized in an optimum manner, the screen can be moved along the dashboard in the horizontal direction.

### CLAIM FOR PRIORITY

This application claims priority to German Application No. 10 2004 044 164.4, filed Sep. 13, 2004, which is incorporated herein, in its entirety, by reference.

### TECHNICAL FIELD OF THE INVENTION

The invention relates to a dashboard for a motor vehicle, with a screen for displaying information, the screen being arranged in front of the dashboard as seen by a vehicle occupant.

### BACKGROUND OF THE INVENTION

The number of displays to be arranged in a dashboard, which has risen greatly in recent years, means that the most important driver information, in particular the speed display, is provided on the dashboard in a primary region which can be directly seen by the driver. Less important information is displayed in the secondary region. This less important information is, for example, comfort information including the parameters currently set for the air-conditioning system or else information for navigating the motor vehicle. The displays of the on-board computer are also part of the secondary information. This on-board computer shows, for example, the average journey time, the current or average fuel consumption, or the expected arrival time. For this type of additional information, a screen or display which displays the respective information is usually provided in or on the dashboard. It is important to use a large screen with high resolution, especially for navigating a motor vehicle. The screens used are often liquid-crystal displays (LCDs) which have the disadvantage that they can be very difficult to read at specific viewing angles.

Although information systems in motor vehicles have the advantage of providing the driver with comprehensive information, they do carry the risk of distracting the driver from what is happening on the road. In order to reduce this effect, DE 41 286 63 C2 discloses a dashboard for a motor vehicle, with a screen for displaying information and a keypad for calling up the respectively desired information, the screen being formed as a component which can be moved in a vertical direction out of the contour of the dashboard by mean of an actuating motor, and can be moved out of a shaft which leads into the dashboard from above. However, this has the disadvantage that when the screen is moved out of the dashboard, said screen is arranged only in a fixed position, for example in the middle of the vehicle.

### SUMMARY OF THE INVENTION

The invention discloses forming a dashboard such that the screen can be read equally well both by the driver and by the passenger, depending on requirements, with the installation space in the region of the dashboard at the same time being utilized in an optimum manner.

According to one embodiment of the invention, the screen can be moved along the dashboard in the horizontal direction. This has the advantage that the driver of the vehicle or the passenger can read the screen in an optimum manner, depending on requirements. Furthermore, the ability of the screen to move means that the installation space in the region of the dashboard is utilized in an optimum manner. Therefore, by way of example, a CD input or an area comprising operator control elements may be covered by the screen, provided that the area is not needed. However, if the CD input is needed, for example to change a CD, the screen can be easily moved into a position in which it does not cover the CD input area. In this case, the screen may be able to move vertically by approximately 30 to 70 cm.

In one embodiment, the screen can be moved by means of a linear drive. As a result, the screen can be moved into the desired position in a very convenient and reliable manner.

In another embodiment, the linear drive is in the form of an electromechanical drive. This is a relatively cost-effective embodiment which ensures a high degree of operational reliability. As an alternative to this, the linear drive is in the form of an electrohydraulic drive. This is a very high quality form of linear drive which is very reliable even when very highly loaded.

In still another embodiment, an electronic memory is formed which stores positions of the screen once the positions have been determined and which, in accordance with the wishes of a vehicle occupant, drive the linear drive such that the screen moves to the stored position. This is particularly advantageous when the vehicle is used by a large number of vehicle occupants because it is possible to recreate individual settings for different vehicle occupants without any great effort.

### BRIEF DESCRIPTION OF THE DRAWINGS

The invention is described in more detail below with reference to the exemplary embodiments and drawings, in which:

FIG. 1 shows a module carrier with a screen.

FIG. 2 shows a rear view of the module carrier.

FIG. 3 shows the front view, illustrated in FIG. 1, of the module carrier from a different perspective.

### DETAILED DESCRIPTION OF THE INVENTION

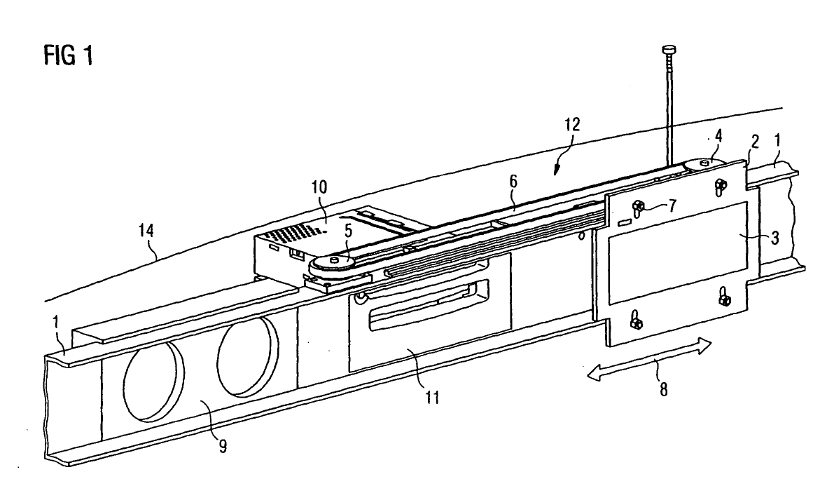

FIG. 1 shows a module carrier 1 which is permanently integrated in a dashboard (14). By way of example, a holder 9 for the combination instrument (not illustrated here) is integrated in this module carrier 1. This combination instrument displays the primary driving information to the driver. The driving information includes the current vehicle speed. An electronic device 10 which is fixed to the module carrier 1 is also shown. This electronic device 10 may be an audio system or a navigation system, for example. Audio systems and navigation systems are generally supplied with data from a compact disc (CD) which is fed to the electronic device 10 via the CD shaft 11. Since the installation space is as a rule greatly restricted in the region of the dashboard, it is necessary to use the installation space in front of the CD shaft 11 for the screen 3, for example. For this purpose, the screen 3 is mounted on a screen mount 2. In order to be able to expose the CD shaft 11, the screen mount 2 is connected to a linear drive 12 by means of fixing elements 7. The linear drive is an electromechanical linear drive which comprises an electric motor (not illustrated here), a first roller 4, a second roller 5 and a conveyor belt 6. The screen mount 2 is fixed to the conveyor belt 6 and mounted on the module carrier 1 such that it can move. When, for example, the first roller 4 is driven by an electric motor, the screen mount 2 with the screen 3 is moved in the horizontal direction. The direction 8 of movement is indicated by the double-headed arrow. This horizontal movement of the screen mount 2 and the screen 3 has the first advantage that the CD shaft 11 is exposed by the screen mount 2 when necessary and, depending on requirements, the screen 3 can be read both by the driver of the motor vehicle and by the passenger of the motor vehicle in an optimum manner. For this purpose, the screen 3 can be moved in the horizontal direction by approximately 30 to 70 cm.

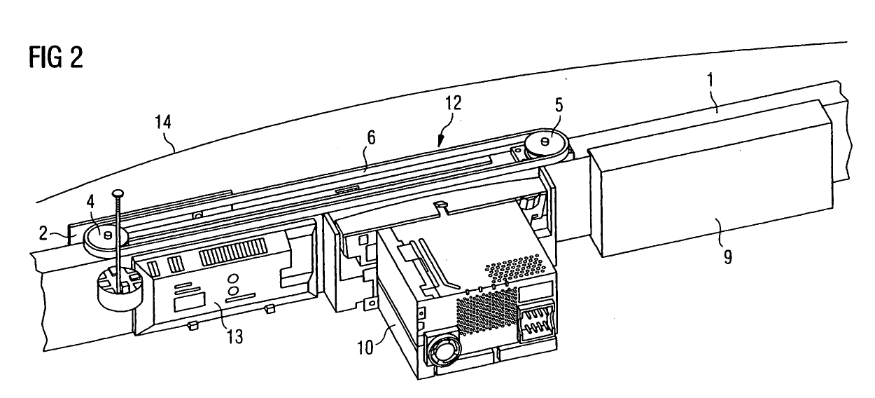

FIG. 2 shows a rear view of the module carrier 1. The figure shows the holder 9 for the combination instrument, the electronic device 10, a further electronic device 13 and the drive 12. In this case too, the linear drive 12 is in form of an electromechanical drive and comprises electric motors (again not illustrated here) and a first roller 4, a second roller 5 and the conveyor belt 6. The screen mount 2 is connected to the conveyor belt 6 and mounted on the module carrier 1 such that it can move in this case too. In addition to the electromechanical embodiment illustrated here, the linear drive 12 may also be in the form of an electrohydraulic system or convert electrical signals into linear actuating movements in some other way. The important factor here is that, due to the linear drive 12, the screen 3 can be seen in an optimum manner by the passenger (not illustrated here) in one position, and can be seen in an optimum manner by the driver of the motor vehicle in another position. It is of course also feasible for the screen to be moved in the horizontal direction manually, that is to say without an electrical linear drive.

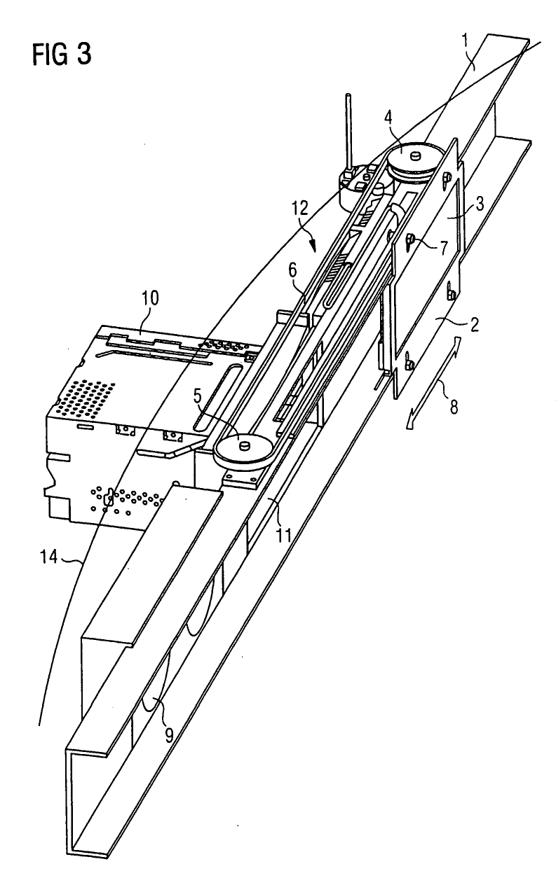

FIG. 3 shows the front view of the module carrier 1 known from FIG. 1 from a somewhat different perspective. The holder 9 for the combination instrument, an electronic device 10, the linear drive 12 and the screen mount 2 with the screen 3 can again be seen. The screen mount 2 is fixed to the conveyor belt 6 of the linear drive 12 by the fixing elements 7. At least one electric motor drives the first roller 4 or the second roller 5, as a result of which the screen mount, together with the screen, can be moved along the module carrier in the horizontal direction. In this case too, the direction 8 of movement of the screen mount 2 with the screen 3 is indicated by the doubleheaded arrow. The figure shows the CD shaft 11 which is either covered or exposed by the screen mount 2 depending on the position of the latter. If the CD shaft 11 is covered by the screen mount 2, the driver of the motor vehicle, who is generally positioned in front of the combination instrument, can read the screen 3 in an optimum manner. If, in contrast, the screen mount 2 is moved horizontally to the right, the CD shaft 11 is exposed and the passenger can see the screen 3 in an optimum manner and read its contents.

What is claimed is:

1. A dashboard for a motor vehicle, comprising a screen for displaying information, the screen being arranged in front of the dashboard as seen by a vehicle occupant, wherein the screen is configured to be moved along the dashboard in the horizontal direction.

2. The dashboard for a motor vehicle as claimed in claim 1, wherein the screen is configured to be moved by means of a linear drive.

3. The dashboard for a motor vehicle as claimed in claim 2, wherein the linear drive is in a form of an electromechanical drive.

4. The dashboard for a motor vehicle as claimed in claim 2, wherein the linear drive is in a form of an electrohydraulic drive.

5. The dashboard for a motor vehicle as claimed in claim 3, further comprising an electronic memory which stores positions of the screen once the positions have been determined and which, drive the linear drive such that the screen moves to the stored position.
